(19) United States
(12) Patent Application Publication
(10) Pub. No.: US 2004/0026882 A1
(43) Pub. Date: Feb. 12, 2004

(54) Convertible luggage device

(76) Inventor: Deborah Brown, Nampa, ID (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/839,900

(22) Filed: Apr. 20, 2001

(51) Int. Cl. B62B 3/00

(52) U.S. Cl. 280/47.34

(57) ABSTRACT

A convertible luggage device including a retractable handle assembly and at least one pair of extendable wheels. Included is a brake system operating to lock at least one of the wheels. In one aspect, the device forms a stroller. In another aspect, the device includes straps for engaging a car seat or a basket for receiving luggage or other items. By embodying a broad wheel base, the present invention provides a stable platform for pushing or pulling luggage or for performing as a stroller.

### BACKGROUND OF THE INVENTION

The present invention relates generally to convertible luggage devices and more particularly to luggage devices that can be alternatively pushed or pulled and which provide structure that is multi-functional.

Convenience is an important consideration in luggage choice. Families who travel with small children often bring strollers, car seats, diaper bags, carry-on bags and a host of other items. Those traveling without children also must contend with transporting a number of items.

Prior luggage devices have been developed with wheels so that the luggage can be rolled rather than continuously carried. Luggage including two or four wheels have previously been produced. While such luggage can conceivably be pushed, most devices are designed to be pulled behind the traveler.

Luggage having convertible aspects have also been developed. Such luggage includes pivoting structure and complimentary structures that can be used as a sitting stool or as a baby stroller. Conventional luggage devices with convertible aspects have also been configured to be pushed rather than pulled behind a traveler.

However, prior devices can lack sufficient convenience for an individual to make it a luggage choice. For example, a number of conventional luggage devices are not equipped with a stable wheel base. The devices easily tip over in response to a lateral force. Other luggage devices lack structure for easy conversion into a stroller or push cart. That is, the conventional devices require several steps to transform, fold or unfold the various structures of the device. Still other conventional luggage devices lack necessary safety features to make them a luggage choice.

What is needed and heretofore unavailable is a convertible luggage device that incorporates basic travel needs into a single component that is easy to push, fold, store and stack. What is also needed is a luggage device that is convertible to thereby provide multiple carrying functions. The present invention satisfies these and other needs.

### SUMMARY OF THE INVENTION

Briefly and in general terms, the present invention is directed towards a luggage device that is convenient to use. In one aspect, the luggage device of the present invention is convertible from a hand carried storage device to a rolling piece of luggage.

In another aspect, the luggage device of the present invention includes a pivoting handle and extendable wheels. In one preferred embodiment, the storage area of the luggage device has a generally horizontal profile and a relatively long wheel base that provides stability during transport.

The luggage device of the present invention can be equipped with stroller components. The stroller components are retractable to a position adjacent a long side of the storage compartment. In its unfolded configuration, the stroller components define a seat for a child and further include safety straps for holding the child in the seat. A braking assembly is provided to insure that the luggage device does not roll until after conversion into a stroller and upon a positive step being taken to deactivate the brake.

In yet another aspect, the present invention includes structures for accomplishing the automatic extension and retraction of the wheels. To wit, it is contemplated that the pivoting handle of the luggage device cooperates with lever mechanisms to set a desired position of certain of the wheels of the device.

In other preferred embodiments, the stroller components can be lacking or can be removed from the luggage device. The present invention can further include a strapping system for receiving a child car safety seat. Alternatively, the device can be equipped with a foldable basket designed to receive other luggage or travel items.

The convertible luggage device of the present invention also embodies a profile well suited for stacking when placed in its folded configuration as well as zipper accessible compartments for storing convertible portions of the device. Additionally, resting of one luggage device upon another allows for transporting a plurality of devices.

These and other objects and advantages of the invention will become apparent from the following more detailed description, when taken in conjunction with the accompanying drawings of illustrative embodiments.

### BRIEF DESCRIPTION OF THE DRAWINGS

FIG. 1 is a perspective view, depicting a convertible luggage device of the present invention;

FIG. 2 is a perspective view, depicting the luggage device shown in FIG. 1 with a handle assembly in a projected position;

FIG. 3 is a perspective view, depicting the luggage device of FIG. 2 in tilted for pulling or pushing on wheels;

FIG. 4 is a cutaway view, depicting convertible structures of the luggage device of the present invention in a retracted position;

FIG. 5 is a cutaway view, depicting convertible structures of the luggage device shown in FIG. 4 in a deployed position;

FIG. 6 is a partial view, depicting a handle and brake assembly of a luggage device of the present invention;

FIG. 7 is an enlarged cutaway view, depicting aspects of the handle and brake assembly shown in FIG. 6;

FIG. 8 is a perspective view, depicting one embodiment of the present invention;

FIG. 9 is a perspective view, depicting another embodiment of the present invention; and

FIG. 10 is a perspective view, depicting yet another embodiment of the present invention.

### DETAILED DESCRIPTION OF THE PREFERRED EMBODIMENTS

As shown in the drawings, which are included for purposes of illustration and not by way of limitation, the present invention is embodied in a convertible luggage device that has structures providing multi-functionality. Referring to FIG. 1, the luggage device 20 of the present invention includes a body or container portion 22 having a top 24, a bottom 26 and a plurality of sidewalls 28. Although the luggage device is shown as having a generally rectangular box configuration in its fully retracted form, various other shapes are possible. To wit, it is contemplated that for a particular purpose, the luggage device can, for example, lack well-defined sidewalls 28. In the embodiment shown in the figures, the luggage device 20 has a long dimension 30 and two shorter dimensions 32, 34 to thereby define the rectangular box shape. As such, the luggage device 20 has a horizontal or low profile when placed so that the long dimension 30 is touching or parallel to the ground.

The luggage device 20 further includes a first pair of wheels 36 and a second pair of wheels 38 each of which project or are projectable from the bottom 26 of the luggage device 20. It is contemplated that in a preferred embodiment, the pairs of wheels be spaced sufficiently to provide the luggage device 20 with a broad wheel base, thus making the device highly stable. The device 20 further includes a retractable handle assembly 40, the details of which are provided below.

The luggage device 20 additionally includes a plurality of zippers providing access to various compartments of the luggage device 20. A first zipper 42 is configured in a top lid 44 of the luggage device 20 and provides access to a pocket or storage compartment in the top lid 44. A second zipper 46 provides a means for removing or opening the top lid 44 to gain access to for example, convertible structures stored therein. A third zipper 48 provides access to an interior compartment of the body or main portion 22 of the luggage device 20. The interior compartment can be used for transporting travel items. Finally, a fourth zipper 50 provides access to the interior compartment when the luggage device 20 has been converted to a deployed configuration.

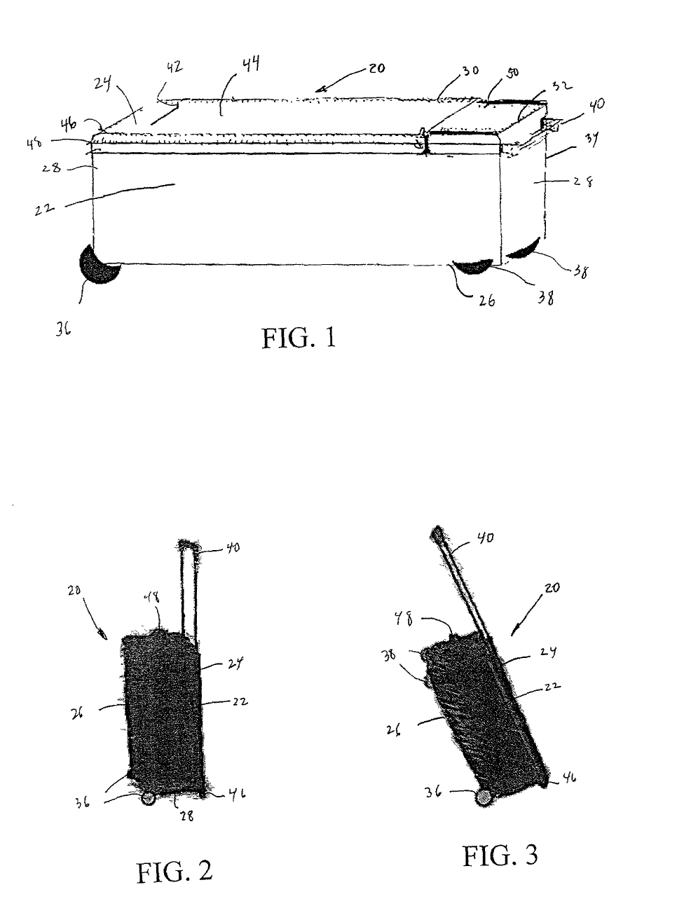

As shown in FIGS. 2 and 3, the luggage device 20 can be placed generally vertically on a sidewall 28 and the handle assembly 40 can be placed in an extended position. When tilted onto the first pair of wheels 36, the device 20 can be pushed or pulled as desired by applying a force to the handle assembly 40. In order to provide stability when placed in a vertical position, the luggage device 20 can include a support or pair of spaced supports 46 which extend approximately the same distance from the sidewall 28 as the first pair of wheels 36. The second pair of wheels 38 are shown in a retracted position. The device can further be equipped with a grasping structure 48 attached to another of the sidewalls 28 located proximate the handle assembly 40. The grasping structure 48 allows a traveler to carry the luggage device 20 when convenient.

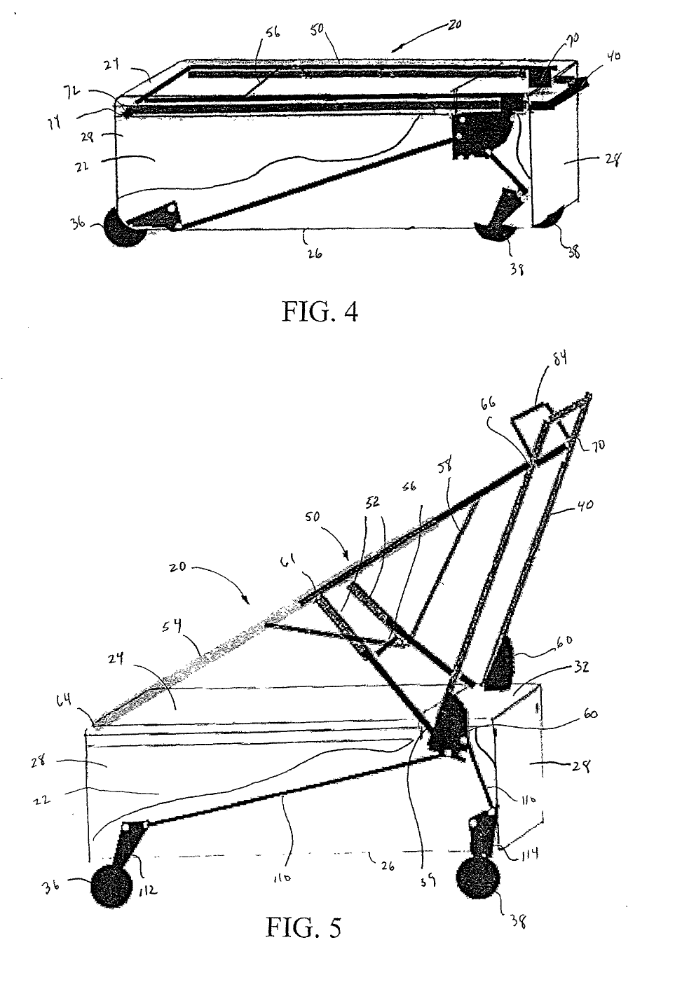

Turning now to FIGS. 4 and 5, one embodiment of the convertible structure 50 of the luggage device 20 of the present invention is shown. In a retracted form (FIG. 4), the convertible structure is folded against the body portion 22. When expanded (FIG. 5), the convertible structure defines a basket, a platform for a car seat, or a stroller seat.

In one aspect, the convertible structure 50 projects from the top side 24 of the luggage device 20. As stated, access to the convertible structure 50 may be accomplished by unzipping the top lid 44. The convertible structure 50 includes a pair of spaced folding diagonal supports 52 that engage spaced telescoping support tubes 54. Moreover, the convertible structure includes a horizontal seating support bar 56 and at least a pair of angled seating supports 58, each of which are connected to midsection portions of one or more of the folding diagonal support 52 or telescoping support tubes 54 to thereby define a seat or a receiving element for a car seat. A web spanning these members and safety straps are further provided, such structures being removable as desired.

As shown in the drawing figures, in a deployed configuration, the telescoping support tubes 54 and the handle 40 define a support triangle with the top 22 of the luggage device 20. Bisecting that triangular support are the folding diagonal supports 52, one end 59 of each of which is operatively associated with a first bracket 60 and a second end 61 engages a midsection portion of the telescoping support tube 54. A first end 64 of each of the telescoping support tubes is pivotably mounted to the top 24 of the body 22 of the luggage device, whereas a second end 60 of each of which engages the handle assembly 40.

In one preferred embodiment, the second end 60 of the telescoping support tubes include a locking hinge collar 70 which operates to lock the handle 40 in a generally upright or deployed position (FIG. 5). A terminal end 72 of the handle assembly can be configured within a guide (not shown) or can be free floating and can further include a brake lock 74. Where the device 20 includes a guide, the terminal end 72 of the handle assembly 40 can be slid transversely in a controlled manner when being deployed. When a guide is not provided, control during deployment is provided by the interconnection and cooperation of the handle 40, telescoping tubes 54, folding diagonal support 52 and first bracket 60.

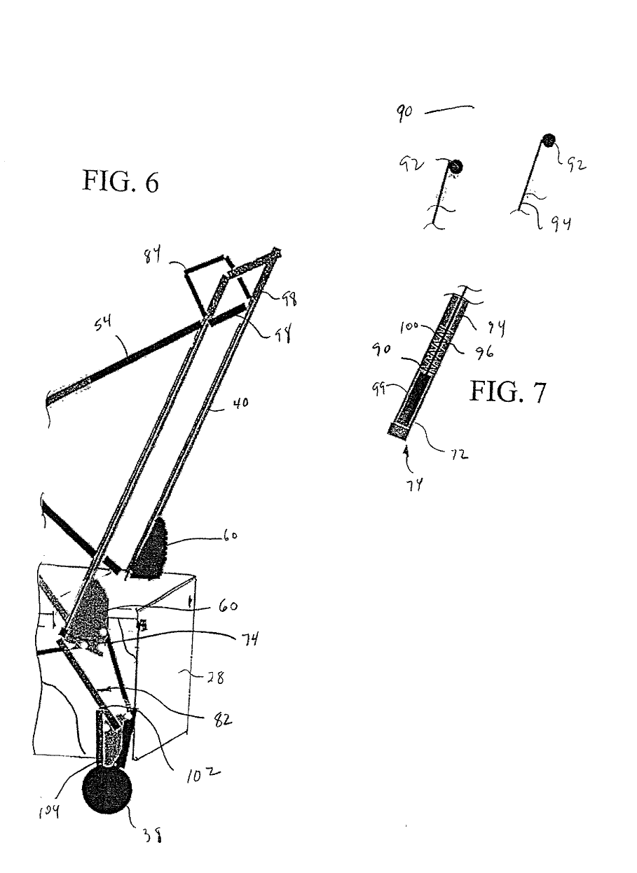

With reference to FIGS. 5-7, the handle assembly 40 and brake and wheel ejection system is described in more detail. After gaining access to the handle assembly 40, one simple tugging or pulling motion accomplishes the deployment of the convertible portion and wheels 36, 38 of the luggage device 20. The handle assembly 40 is held in a generally vertical position by the locking action of the hinge collars 70 and the engagement of the brake lock 74 against a braking lever assembly 82. When the luggage device 20 is so configured, a brake handle 84 pivotably attached to the handle assembly 40 is in an open position as demonstrated by diverging juxta-positioning of the two members and the second pair of wheels 38 are locked.

In a preferred embodiment, the handle assembly further includes a tubular handle portion 90, a pair of pulleys 92, and a pair of cables 94 each of which are fixed to one pulley 92. The cables 94 are separately routed through the tubular handle portions 90 and into engagement with the brake lock 74 attached to the terminal end 72 of the handle assembly 40. The brake lock 74 further includes a piston 99 and a biasing spring 100, the piston 99 being translatable within the tubular portion 90 and the spring 99 being fixed therewithin. Opposing ends 98 of the brake handle 84 can be configured to engage the pulleys 92 so that an action which causes the brake handle 84 to converge with the handle assembly 40, in turn causes the brake 82 to disengage the wheels 38.

In one aspect, the brake lever assembly 82 includes a first elongate rotation component 102 that is configured to engage a second elongate transmission component 104 which applies a direct force upon the wheels 38. It is to be recognized that there may be a separate braking system for each of the second pair of wheels 38 or alternatively, only one such system can be provided for a particular application. In any case, when the handle assembly 40 is fully deployed, the brake lock assembly 74 is placed against the first rotatable component 102 which forces the second translatable component 104 against a wheel 38. Compression of the brake handle 84 against he handle assembly 40 causes the pulleys 92 to rotate and the piston 99 to withdraw. This action operatively causes the second translatable component 104 to be removed from the wheel 38, thereby unlocking the same.

Additionally, when the handle is in its deployed state, the wheels are automatically extended from the bottom 26 of the luggage device. Pulling on the handle assembly 40 causes the first pair of brackets 60 to rotate. Through pivoting lever 110 connections to second and third pairs of rotatable brackets 112, 114, the wheels 36, 38 are caused to project from the luggage device 20. Although the FIGS. depict a luggage device 20 having four retractable/projectable wheels 36, 38, it is also contemplated that only the second pair of wheels be retractable/projectable. Through conventional techniques, the wheels are locked in both the retracted and projected positions.

In a preferred embodiment, the luggage device is designed to be pushed when all four wheels 36, 38 are in an extended or projected position. It is to be recognized, however, that for particular applications, the luggage device 20 can be configured to be pushed or pulled as desired.

The luggage device 20 of the present invention is contemplated to be manufactured from light weight materials. The chassis, including the handles, levers and supporting members can be made from an aluminum and fiberglass composite. The luggage exterior can embody conventional fabrics or a hard shell of plastic or aluminum. The overall dimensions of the luggage device can be selected as desired, while sizes compliant with airline requirements is preferable.

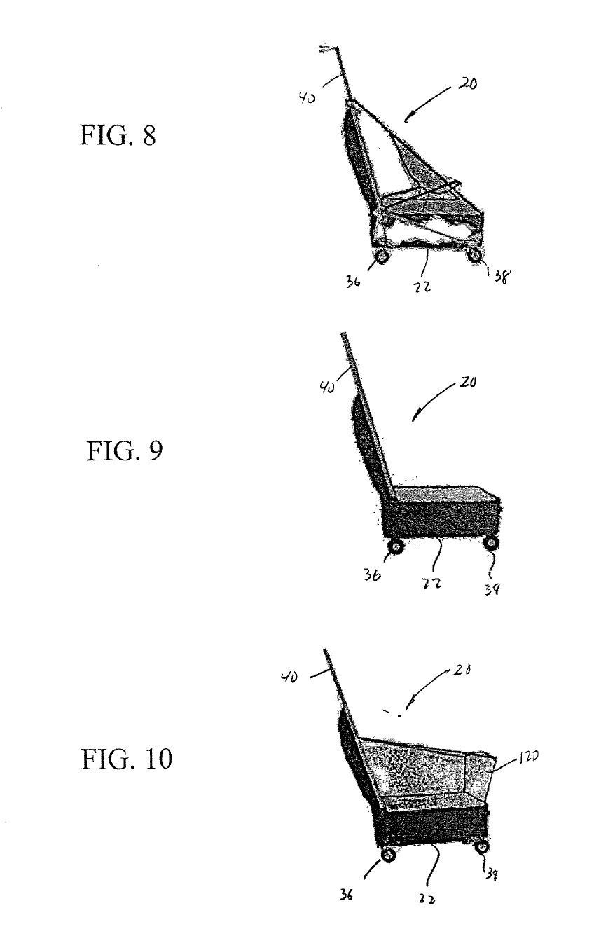

As shown in FIGS. 8-10, various embodiments of luggage device of the present invention are contemplated. The luggage device 20 can be converted into a stroller with a storage compartment or a receptacle for a car seat (FIG. 8) or can simply convert into a pushable luggage device (FIG. 9). The device 20 can also include a basket 12 with a durable inner lining for receiving travel or other items. Due to its contemplated profile, the luggage device 20 of the present invention is also well suited for stacking.

The present invention provides a convenient luggage device that can be pushed or pulled in vertical or horizontal positions and which is convertible into various forms. One easy pulling motion on the handle assembly of the luggage device of the present invention accomplishes the extension of the wheels as well as the locking of at least one wheel of the device and the deployment of the convertible portion thereof. A simple second compression force applied to the brake handle releases the lock on the wheels and the luggage device is ready for use.

It will be apparent from the foregoing that, while particular forms of the invention have been illustrated and described, various modifications can be made without departing from the spirit and scope of the invention. Accordingly, it is not intended that the invention be limited, except as by the appended claims.

What is claimed is:

1. A convertible luggage device, comprising:
a main body having a long side and at least one short side;
a first pair of wheels and a second pair of retractable wheels, the first and second pairs of wheels configured to span substantially the length of the long side; and
a pivoting handle assembly operatively connected to the second pair of retractable wheels whereby actuation of the handle assembly accomplishes retraction and ejection of the second pair of wheels.

2. A convertible luggage device of claim 1, wherein the first pair of wheels are retractable and activation of the handle assembly accomplishes retraction and ejection of the first pair of wheels.

3. A convertible luggage device of claim 1, the pivoting handle assembly further including a brake system.

4. A convertible luggage device of claim 3, wherein the brake system operates to control rotation of at least one of the second pair of retractable wheels.

5. A convertible luggage device of claim 4, the brake system further including a cable attached to a pulley configured within a tube defining the pivoting handle.

6. A convertible luggage device of claim 5, the brake system further including a compression brake arrangement that cooperates with the pulley and cable.

7. A convertible luggage device of claim 6, the brake system further including a brake handle operatively connected to the brake cable, activation of the brake handle accomplishing deactivation of the brake.

8. A convertible luggage device of claim 1, wherein the convertible luggage device is designed to have a substantially horizontal profile.

9. A convertible luggage device of claim 1, further comprising a retractable stroller assembly connected to the long side of the main body.

10. A convertible luggage device of claim 9, the retractable stroller further including a seat and at least one strap for holding a child in the seat.

11. A convertible luggage device of claim 10, the long side of the main body further comprising a zipper accessible compartment for receiving the stroller assembly in a folded state.

12. A convertible luggage device of claim 1, further comprising a basket assembly connected to the long side of the main body.

13. A convertible luggage device of claim 12, the basket assembly defining a generally rectangular space with an open top.

14. A convertible luggage device of claim 13, the basket assembly having walls defined by netting.

15. A convertible luggage device of claim 1, further comprising a strapping system for engaging a child car safety seat.

16. A convertible luggage device of claim 1, wherein the luggage device is capable of being transported generally vertically and supported on the first pair of wheels.

17. A convertible luggage device of claim 1, further comprising a first zipper accessible compartment that provides access to an interior of the main body.

18. A convertible luggage device of claim 17, further comprising a second zipper accessible compartment that is configured receives convertible structure of the luggage device.

19. A convertible luggage device of claim 1, wherein the handle assembly includes structure that automatically locks at least one wheel when the handle assembly is pivoted into a first position.

20. A convertible luggage device of claim 1, further comprising a force activated compression brake.
